(19) United States
(12) Patent Application Publication
(10) Pub. No.: US 2009/0164583 A1
(43) Pub. Date: Jun. 25, 2009

(54) METHOD AND APPARATUS FOR SERVICES SHARING IN A COMMUNICATIONS NETWORK

(75) Inventor: Zhongwen Zhu, Saint-Laurent (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/961,924

(22) Filed: Dec. 20, 2007

(51) Int. Cl. G06F 15/16

(52) U.S. Cl. 709/205

(57) ABSTRACT

The invention relates to a method for services sharing in a communications network having the following steps. First, a server or a User Equipment (UE) creates a group of users and defines one or more services owned by one or more users of the group of users as services shared by the group of users and available for use by users of the group of users. The users of the group can then receive a list of the services shared, add a new service to the services shared, search for a service, receive a service status for a service, use a service or remove a service from the list of services shared by the group of users. A server and a UE implementing the method are also provided.

### FIELD OF THE INVENTION

The present invention relates to services sharing in a communications network, and more particularly to a method and apparatuses for services sharing in a communications network.

### BACKGROUND OF THE INVENTION

In today's wireless world, multiple forms of communications are available to users using devices such as mobile phones, handhelds, portable computers etc. Service providers propose several services to their users, which may or may not subscribe to these services. Often, when a user subscribes to a limited number of services, which are seldom used, the user ends up paying to much money for the use made of these services.

Although there is no prior art as the Applicant's invention, the Patent application publication KR2005080524A generally relates to the field of the present invention. This publication describes sharing a service by Bluetooth communication in mobile communication terminals, allowing a plurality of mobile terminals to share a service through the Bluetooth communication in real time.

Patent application publication US20050004387A1 also bears some relation with the field of the present invention. This publication describes techniques for sharing services between an electronic device that support wireless communications functionality and wireless devices such as cellular phones including a designated button used to initiate service sharing with the electronic device.

Too often, users pay for a limited number of services that might be seldom used and would therefore benefit from a method for services sharing.

### SUMMARY

It is an object to obviate at least some of the above disadvantages and provide services sharing in a communications network.

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

According to an aspect of the invention a method for services sharing in a communications network is provided. The method comprises the following steps. First a group of users is created. Then, at least one service owned by at least one user of the group of users is defined as at least one service shared by the group of users, the at least one service shared being available for use by at least one user of the group of users.

According to another aspect of the invention a server for services sharing in a communications network is provided. The server comprises a user group manager that is configured to create a group of users and a user group service manager that is configured to define at least one service owned by at least one user of the group of users as at least one service shared by the group of users, said at least one service shared being available for use by at least one user of the group of users.

According to yet another aspect of the invention, a services sharing enabled User Equipment (UE) for use in a communications network is provided. The UE comprises a group service management module that is configured to trigger a creation of a group of users and to select at least one service owned by at least one user of the group of users as at least one service shared by the group of users, said at least one service shared being available for use by the at least one user of the group of users.

### BRIEF DESCRIPTION OF THE DRAWINGS

The objects and advantages of the invention will be understood by reading the following detailed description in conjunction with the drawings.

FIG. 1 is an exemplary flowchart illustrating operations executed in a server according to an embodiment of the invention.

FIG. 2 is an exemplary flowchart illustrating operations executed in a UE according to an embodiment of the invention.

FIG. 3 is an exemplary block diagram showing components of a server according to an embodiment of the invention.

FIG. 4 is an exemplary block diagram showing components of a UE according to an embodiment of the invention.

FIG. 5 to 7 are exemplary illustrations of a system according to an embodiment of the invention.

FIG. 8 is an exemplary diagram illustrating a data flow according to an embodiment of the invention.

### DETAILED DESCRIPTION

The various features of the invention will now be described with reference to the figures. These various aspects are described hereafter in greater detail in connection with a number of exemplary embodiments to facilitate an understanding of the invention, but should not be construed as limited to these embodiments. Rather, these embodiments are provided so that the disclosure will be thorough and complete, and will fully convey the scope of the invention to those skilled in the art.

Many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention.

Embodiments according to the present invention are described with reference to block diagrams and/or operational illustrations of methods, UEs, servers, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Furthermore, in some illustrations, some blocks may be optional and may or may not be executed.

As used herein, a “UE” includes, but is not limited to, a device that is configured to receive communication signals via a wired of wireless interface from, for example, a cellular network, a Wide Area Network, a local area network (LAN), the internet, a wireless local area network (WLAN), a GPS system, and/or another RF communication device. A UE may form a network structure integrated with other networks, such as the Internet, via cellular or other access networks, or as a stand alone ad-hoc network in which UE directly communicate with one another (e.g., peer-to-peer) through one or more signal hops, or combination thereof. Examples of ad-hoc networks include a mobile ad-hoc network (MANET), a mobile mesh ad-hoc network (MMAN), and a Bluetooth-based network, although other types of ad-hoc networks may be used. Exemplary UE include, but is not limited to, a cellular mobile terminal; a personal communication terminal that may combine a cellular mobile terminal with data processing and data communications capabilities; a personal data assistance (PDA) that can include one or more wireless transmitters and/or receivers, pager, Internet/intranet access, local area network interface, wide area network interface, Web browser, organizer, and/or calendar; and a computer or a mobile computer or other device that includes one or more network transmitters or receivers.

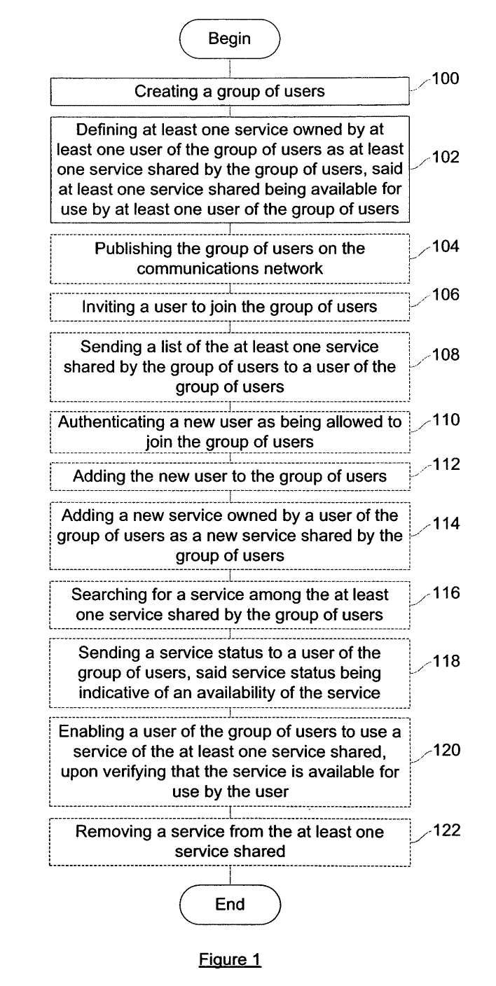

FIG. 1 is an exemplary flowchart illustrating the steps of a method for services sharing in a communications network. The basic steps are illustrated in rectangles having a continuous contour in FIG. 1 and are preferably executed in a server. The method comprises the steps of creating a group of users, step 100 and defining at least one service owned by at least one user of the group of users as at least one service shared by the group of users, the at least one service shared being available for use by at least one user of the group of users, step 102.

The method can also have several other steps which are illustrated in rectangles having dashed contours in FIG. 1. Preferably, the method can comprises a step of publishing the group of users in the communications network, step 104. The publication can take the form of making the group searchable or visible to users of the network. Furthermore, the step of publishing can comprise inviting or sending an invitation to one or many users to join the group of users, step 106.

Still preferably, the method can comprise the step of sending a list of services shared by the group of users to one or many users of the group of users, or to user not yet member of the group of users, step 108. When a new user desires to join the group, the server preferably authenticates the new user as being allowed to join the group of users, step 110 and adds the new user to the group of users, step 112. The authentication of the user can be based on attributes of the user or attributes of the group characterizing the users allowed to join the group. The authentication can also be based on a list of predetermined users allowed to join the group or any other suitable criteria as it would be apparent to a person in the art.

Preferably, the method can comprise the step of adding a new service owned by a user of the group of users as a new service shared by the group of users, step 114. Accordingly, the number of services shared among the group of users can increase with the addition of new users bringing with them their services.

Still preferably, the method can further comprise the step of searching for a service among the services shared by the group of users, step 116. The method can also comprise the step of sending a service status to a user of the group of users, the service status being indicative of an availability of the service, step 118. The service status could also indicate if the user is allowed to use the service, if the service is currently in use by another user or available or any limitations associated with the service, etc.

Preferably, the method can also comprising the step of enabling a user of the group of users to use a service among the services shared, upon verifying that the service is available for use by the user, step 120. The method can also comprise step of removing a service from the services shared, step 122. This can be done either when a user quits the group of users, when a user stops subscribing to a service or when a user decides to stop sharing the service.

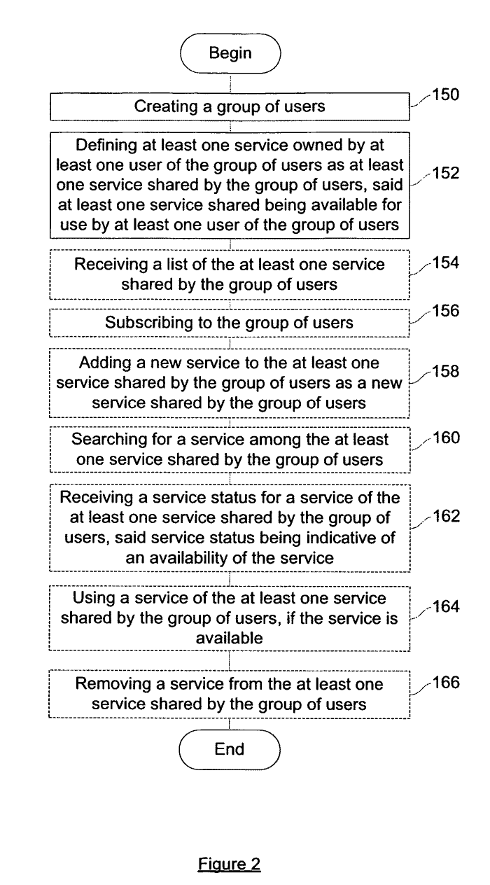

FIG. 2 is an exemplary flowchart illustrating the steps of a method for services sharing in a communications network. The basic steps are illustrated in rectangles having a continuous contour in FIG. 1 and are preferably executed in a UE. The method comprises creating a group of users, step 150 and defining at least one service owned by at least one user of the group of users as at least one service shared by the group of users, the at least one service shared being available for use by at least one user of the group of users, step 152. When the method is executed in a UE, the steps of creating a group of users and selecting at least one service can be executed in the UE or can be initiated by the UE and executed in the server.

The method can also have several other steps which are illustrated in rectangles having dashed contours in FIG. 2. Preferably, the method can comprises the step of receiving a list of the services shared by the group of users, from the server, step 154. This list can take many forms, such as a list of every single service available, a list of all the types of services available, a list of services provided by certain categories of users, a list of services of certain categories, or any other type of list, as it would be apparent to a person in the art, etc.

Preferably, the method can also comprise the step of subscribing to the group of users, step 156, i.e. a user using the UE can, from his UE or from another terminal or mobile device, request a subscription to the group. The method can also comprise the step of adding a new service to the services shared by the group of users as a new service to be shared by the group of users, step 158.

Preferably, the method can further comprise the step of searching for a service among the at least one service shared by the group of users, step 160, the step of receiving a service status for a service of the at least one service shared by the group of users, the service status being indicative of an availability of the service, step 162 and the step of using a service of the services shared by the group of users, if the service is available, step 164. Furthermore, the method can comprise the step of removing a service from the services shared by the group of users, step 166.

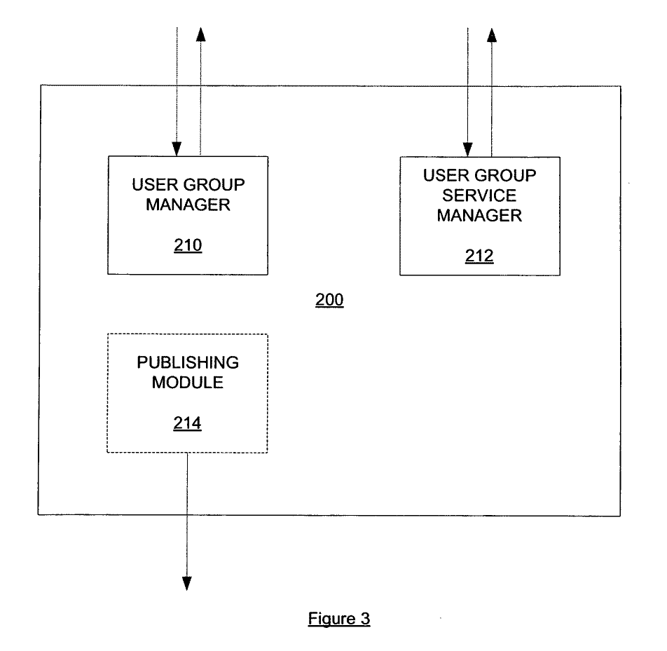

FIG. 3 is an exemplary block diagram showing components of a server 200 for services sharing in a communications network. The server 200 comprises a user group manager 210 that is configured to create a group of users and a user group service manager 212 that is configured to define at least one service owned by at least one user of the group of users as at least one service shared by the group of users, the at least one service shared being available for use by at least one user of the group of users. Preferably, the server can also comprise a publishing module 214 that is configured to publish the group of users in the communications network and to invite one of more users to join the group of users.

Preferably, the user group manager 210 can also be configured to authenticate a new user as being allowed to join the group of users and to add the new user to the group of users. The user group service manager 212 can also be configured to send a list of the services shared by the group of users to one of more users of the group of users, to add a new service owned by the user of the group of users as a new service shared by the group of users. The user group service manager 212 can further be configured to search for a service among the services shared by the group of users and to send a service status indicative of an availability of the service to the user of the group of users. The user group service manager 212 can further be configured to enable the user to use the service upon verifying that the service is available for use. Finally, the user group service manager 212 can further be configured to remove the service from the services shared.

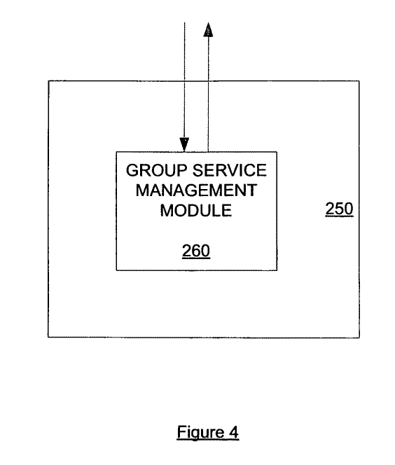

FIG. 4 is an exemplary block diagram showing components of a services sharing enabled UE 250 for use in a communications network. The UE 250 comprises a group service management module 260 that is configured to trigger a creation of a group of users and to select at least one service owned by at least one user of the group of users as at least one service shared by the group of users, the at least one service shared being available for use by the at least one user of the group of users.

Preferably, the group service management module 260 can also be configured to subscribe a user of the UE to the group of users, to receive a list of the services shared by the group of users and to add a new service to the services shared by the group of users. The group service management module 260 can also be configured to search for a service among the services shared by the group of users and to receive a service status for a service among the services shared by the group of users. The group service management module 260 can further be configured to use the service among the services shared by the group of users, if the service is available and to remove the service from the services shared by the group of users.

Preferably, according to an embodiment of the invention and with the help of the Internet Protocol Multimedia Sub-system (IMS) infrastructure, network operators should be able to deploy third party multimedia services into their telecom network. These services are normally hosted by content or service providers who do not own the network infrastructure and accordingly, these services can only be offered to the limited number of subscribers of the network operators. Furthermore, an embodiment of the invention should allow an end user to publish services to which he has subscribed and to let other users in a group or in a community use these services.

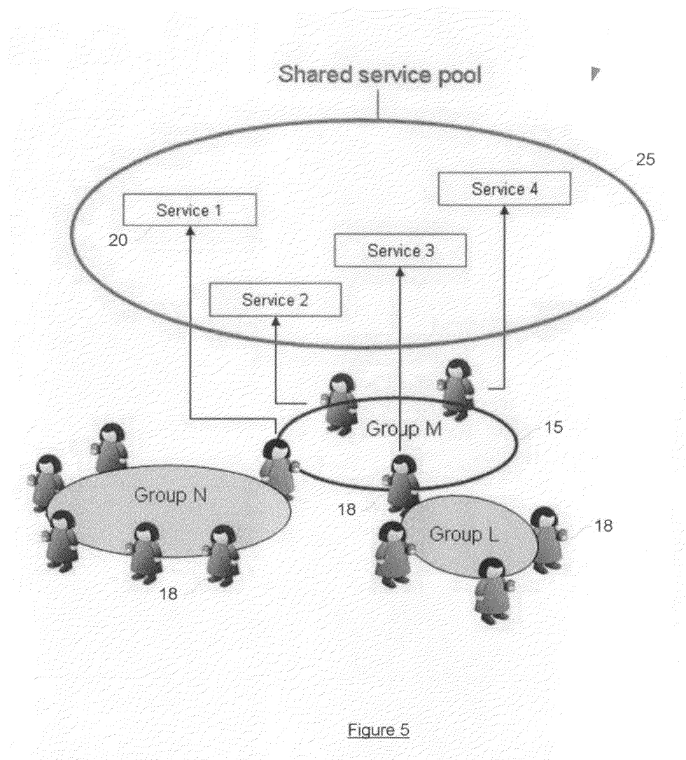

FIG. 5 is an exemplary illustration of a system 1, according to an embodiment of the invention, showing a view on a concept of multimedia services sharing. Preferably, the system 1 allows users in a group or in a community, such as group M, to share the services brought in by members of the group 15, which should be able to share and use services in the service pool 25. A group is preferably associated to a service pool containing services, also called shared services. Preferably, these shared services are brought in by group members and a plurality of members can share the same service within a given group.

Preferably, a service pool 25 hosts information on the services shared by a group of users 15. The services owners 18 can add, modify or delete their services from the pool, as shown in FIG. 5. The services 20 in the service pool 25 can also be publish in the network, thus making all the services in the pool searchable in the network. The service pool 25 allows users 18 to subscribe to the service status, such as added, deleted, available, etc. of services 20 and to receive a notification when a service status changes. A user subscribed to a group, such as group M 15 should be able to use the services in the pool of shared services 25, even if the users sharing these services are subscribers from different operator domains.

Preferably, according to an embodiment of the invention, a user 18 already subscribed to group M should be able to create a new group, for example group L. This user could then share his own services as well as the shared services to which he has access in group M, with the members of group L. Accordingly, a member of group L should be able to use services of groups L and M, the services of group M being shared via the user having created group L.

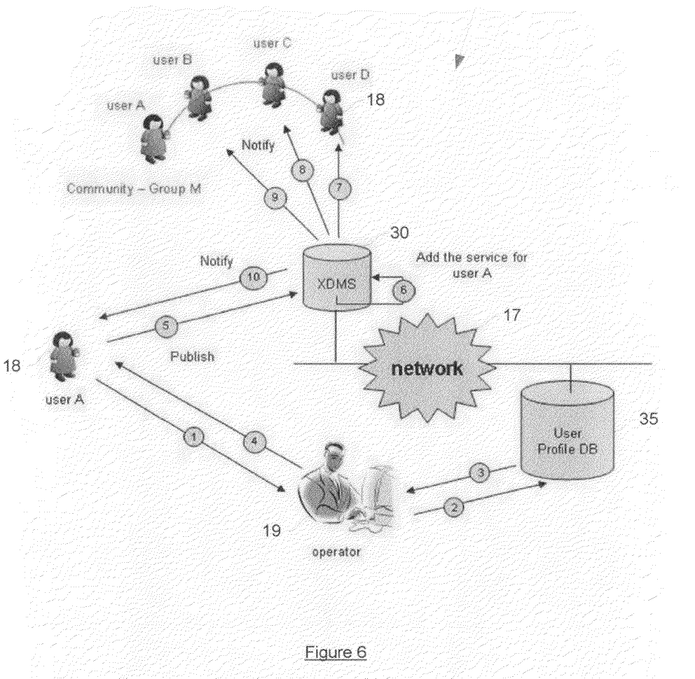

FIG. 6 is another exemplary illustration of a system 1, according to an embodiment of the invention, showing a traffic flow to publish, notify or search the shared services available in the pool of services. Preferably, the system 1 allows users 18 to register or subscribe to a group of users sharing services. For example, user A subscribes to a monthly service package including several services or to a single service with an operator 19, step 1. For each service to which user A subscribes, an operator administrator edits the profile of user A and adds an authorization to use the service into the corresponding database 35, steps 2 and 3. This is a normal procedure for the operator to create or update a user's profile in the network 17. This could also be done automatically, as it would be apparent to a person in the art. The operator 19 then acknowledges to the user that the subscription is effective, step 4.

Still according to FIG. 6, once the subscription to a service is effective, if user A desires to share a service with other users 18, he can publish the service into the service pool by sending a publish request towards XML Document Management Server (XDMS) 30, step 5. The service can then be added into the pool of services, and can be accessible to the users of the group or to a community, for example group M. The service information is therefore added under the user's service profile in group M, step 6.

Preferably, if this is the first time for user A to join the group or the community, user A should also send a subscribe request towards XDMS 30 for group M, prior to being able to add a service in the service pool. Once the service has been added to the service pool, the XDMS 30 can send a first notification to users of the group indicating that a new service has been added, steps 7, 8 and 9. Then, the XDMS 30 can send a second notification containing a list of all the services in the pool back to user A, step 10.

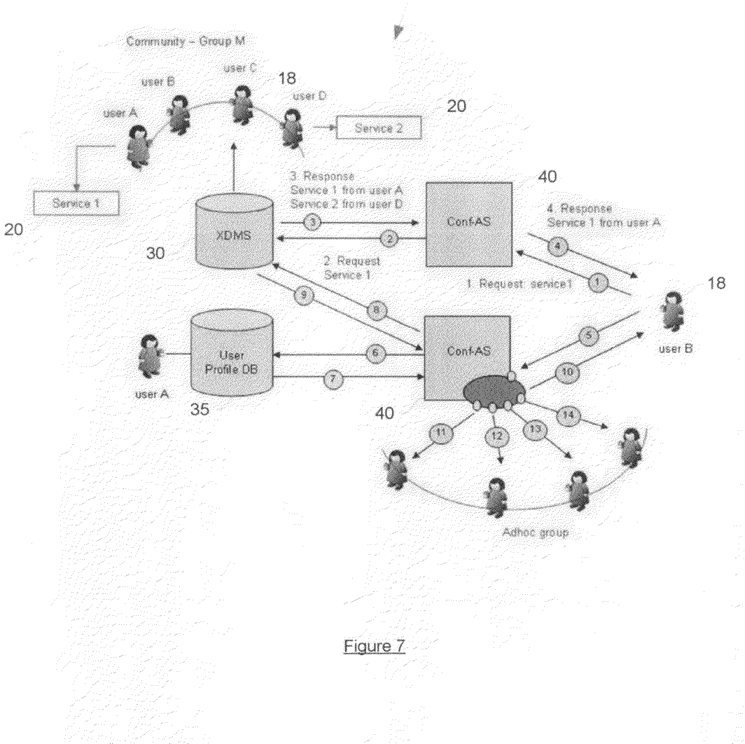

FIG. 7 is another exemplary illustration of a system 1, according to an embodiment of the invention, showing a traffic flow to use the shared services. Preferably, a group member 18, for example user A of group M, should be allowed to search for a specific service 20 or for a list of services 20 in the pool of services. Based upon the response from the XDMS 30, the user A can then select the service 20 and use it. If group M is a public group, all the services can be published in the network 17 (FIG. 6) and should be searchable in the network.

Preferably, the normal procedure to discover a service in the pool of services consists in step 1 to 4 of FIG. 7. User B sends a standard IMS protocol (SIP) request towards conference application server (Conf-AS) 40 using SIP universal resource identifier (URI) for group M, step 1. A special flag could also be included to indicate a request for a specific service, for example service 1. When it receives the request, the Conf-AS 40 should contact the XDMS 30 to retrieve a list of services in the pool, for instance, service 1 and 2, steps 2 and 3. Then, the Conf-AS 40 should pick the right service based on the receive request and send it to user B, step 4.

Preferably, to be able to use a service in the pool of shared services, as for example a conference call service, user B has to retrieve the SIP URI for the service as well as the service owner, in this example, user A. A SIP request is then sent to the Conf-AS 40 hosting the service, step 5. It should be mentioned here that the Conf-AS for user A owning the service 20 might be the same as the one for user B. After receiving the request, the Conf-AS 40 should verify the user profile for user A in the user profile database 35, to make sure that user A is still allowed to use the service, steps 6 and 7. Then, the Conf-AS 40 should also check if user B is authorized to use the service owned by user A, steps 8 and 9. If a permission to use the service is obtained by user B, user B can initiate, for example, a conference call with Adhoc users, to which a request to initiate a conference call is sent, steps 11 to 14. Finally a multimedia service session can be established among all the participants who have accepted the request. Preferably, the multimedia session can only be terminated by user B, user A or the operator providing the service to user A.

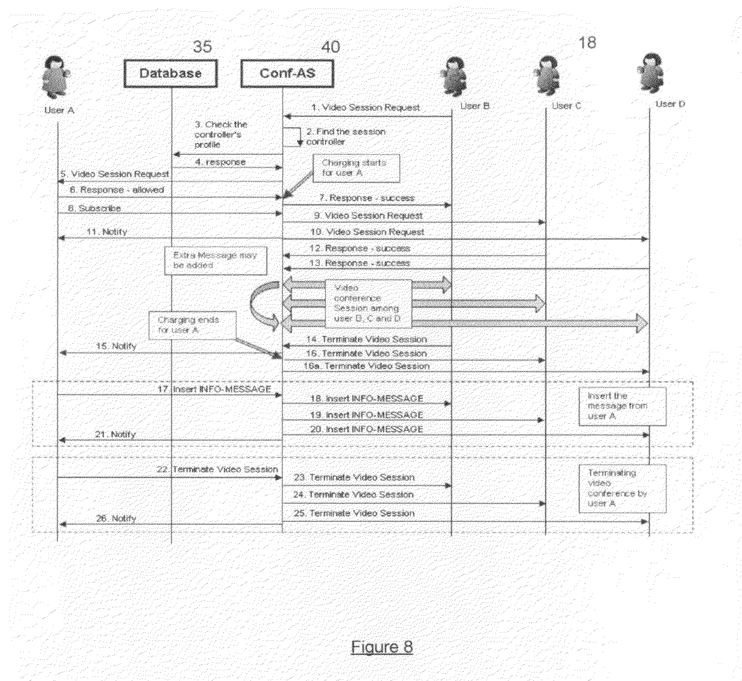

FIG. 8 is an exemplary diagram illustrating a data flow, according to another embodiment of the invention, and how a multimedia session can be established between multiple users. Preferably, if user B wants to set up a video conference, which is a service owned by user A, user B sends a request to set up a video conference session towards the application server, conf-AS 40, that provides the multimedia service. This request preferably includes information pertaining to user A, step 1. The Conf-AS 40 then retrieves the profile of user A from the received request, step 2. The Conf-AS 40 should makes a request to check the profile of user A in the database 35 to verify that user A is allowed to use the service, step 3, and the database should returns a profile for user A, step 4. If user B is not allowed to use the service, there is a possibility that the application server sends a request towards user A for a permission to user the service, step 5. In this case, user A can send an acknowledgment that user B is allowed to use the service in response to the request of the conference application server, step 6. This step is optional if the service is shared and if users A and B are both members of the group in which the service is shared.

Preferably, after is has been establish that user B can use the video conference service owned by user A, the application server sends the response back to user B, step 7. Meanwhile, user A can subscribe to the status of the video conference service, step 8, this step is independent from some of the subsequent steps. The application server then sends a video session setup request towards users C and D, with which user B wants to initiate a video conference, steps 9 and 10. A notification can be sent back to user A if this user has subscribed to receive such notification, step 11. Users C and D can send a positive answer back to the application server, steps 12 and 13, and the video conference can be initiated between users B, C and D. After completing the video conference, user B can send a request to terminating the service, step 14. The application server can then send a notification to user A, indicating that the videoconference has been terminated, step 15. Finally, the application server can send terminating requests to user C and D, step 16.

Preferably, during the ongoing video conference session, user A should be able to inject a message, e.g. text, picture or video clip, into the session, which in turn would send the message to all the participants in the video conference, steps 17 to 21. Furthermore, user A should be able to terminate the ongoing video conference at any time, steps 22 to 26. User A should also be able to hold different sub-sessions at the same time, e.g. chat and video session, etc., each sub-session having its own participants.

This invention is advantageous for end user who would like to share their subscribed services with other users and who would like to be able to make use of services offered by other users. This invention should enable network operator to attract more traffic, should publish the services offered by a service provider and should eventually attract more subscribers who may switch from other operator's domains.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents that fall within the range of the claims are intended to be embraced therein.

What is claimed is:

1. A method for services sharing in a communications network, comprising the steps of:
a) creating a group of users; and
b) defining at least one service owned by at least one user of the group of users as at least one service shared by the group of users, said at least one service shared being available for use by at least one user of the group of users.

2. The method of claim 1, wherein said method is executed in a server.

3. The method of claim 2, further comprising the step of publishing the group of users in the communications network.

4. The method of claim 3, wherein the step of publishing further comprises inviting a user to join the group of users.

5. The method of claim 2, further comprising the step of sending a list of the at least one service shared by the group of users to a user of the group of users.

6. The method of step 2, further comprising the steps of:
c) authenticating a new user as being allowed to join the group of users; and
d) adding the new user to the group of users.

7. The method of step 2, further comprising the step of adding a new service owned by a user of the group of users as a new service shared by the group of users.

8. The method of claim 3, further comprising the step of searching for a service among the at least one service shared by the group of users.

9. The method of claim 8, further comprising the step of sending a service status to a user of the group of users, said service status being indicative of an availability of the service.

10. The method of claim 2, further comprising the step of enabling a user of the group of users to use a service of the at least one service shared upon verifying that the service is available for use by the user.

11. The method of claim 2, further comprising the step of removing a service from the at least one service shared.

12. The method of claim 1, wherein said method is executed in a User Equipment (UE) and wherein the steps of creating a group of users and of selecting at least one service are initiated by the UE.

13. The method of claim 12, further comprising the step of receiving a list of the at least one service shared by the group of users.

14. The method of step 12, further comprising the step of subscribing to the group of users.

15. The method of step 12, further comprising the step of adding a new service to the at least one service shared by the group of users as a new service shared by the group of users.

16. The method of claim 12, further comprising the step of searching for a service among the at least one service shared by the group of users.

17. The method of claim 16, further comprising the step of receiving a service status for a service of the at least one service shared by the group of users, said service status being indicative of an availability of the service.

18. The method of claim 12, further comprising the step of using a service of the at least one service shared by the group of users if the service is available for use.

19. The method of claim 12, further comprising the step of removing a service from the at least one service shared by the group of users.

20. A server for services sharing in a communications network, comprising:
a user group manager that is configured to create a group of users; and
a user group service manager that is configured to define at least one service owned by at least one user of the group of users as at least one service shared by the group of users, said at least one service shared being available for use by at least one user of the group of users.

21. The server of claim 20, further comprising a publishing module that is configured to publish the group of users in the communications network and to invite a user to join the group of users.

22. The server of claim 20, wherein the user group manager is also configured authenticate a new user as being allowed to join the group of users and to add the new user to the group of users.

23. The server of claim 20, wherein the user group service manager is also configured to send a list of the at least one service shared by the group of users to a user of the group of users, to add a new service owned by the user of the group of users as a new service shared by the group of users, to search for a service among the at least one service shared by the group of users, to send a service status indicative of an availability of the service to the user of the group of users, to enable the user to use the service upon verifying that the service is available for use and to remove the service from the at least one service shared.

24. A services sharing enabled UE for use in a communications network, comprising a group service management module that is configured to trigger a creation of a group of users and to select at least one service owned by at least one user of the group of users as at least one service shared by the group of users, said at least one service shared being available for use by the at least one user of the group of users.

25. The UE of claim 24, wherein the group service management module is also configured to subscribe a user of the UE to the group of users, to receive a list of the at least one service shared by the group of users, to add a new service to the at least one service shared by the group of users, to search for a service of the at least one service shared by the group of users, to receive a service status for the service of the at least one service shared by the group of users, to use the service of the at least one service shared by the group of users if the service is available and to remove the service from the at least one service shared by the group of users.
